(19) United States
(12) Patent Application Publication
(10) Pub. No.: US 2013/0104494 A1
(43) Pub. Date: May 2, 2013

(54) INTERSTUD RAIL FASTENING SYSTEM

(71) Applicants: Elio G. Evangelista, Chesterfield, MI (US); Dorian J. Kilgore, Southfield, MI (US)

(72) Inventors: Elio G. Evangelista, Chesterfield, MI (US); Dorian J. Kilgore, Southfield, MI (US)

(73) Assignee: A. Raymond et Cie, Grenoble (FR)

(21) Appl. No.: 13/283,075

(22) Filed: Oct. 27, 2011

(51) Int. Cl. F16L 3/08; B23P 11/00; E04B 1/38; B29C 45/00; F16B 2/06; F16M 13/00

(52) U.S. Cl. 52/741.1; 248/74.1; 248/70; 24/457; 248/316.1; 138/106; 403/291; 29/527.1

(57) ABSTRACT

An interstud rail fastening system is employed. In one aspect, at least one attachment leg, a brim or umbrella, and a coupling post are integrated as a single piece. In another aspect, a clamp is coupled to a fastener having a Christmas tree type engagement segment which is fastened to a building rail. Furthermore, a multiple step fastener is useable with different size building rails. An additional aspect employs a telescopically adjustable rail.

### BACKGROUND AND SUMMARY

The present application generally pertains to an attachment apparatus and more particularly to an interstud rail fastening system.

It is known to attach a snap-in adaptor into an elongated rail or bracket mounted between adjacent studs in a residential or industrial building. Traditionally, a separate post and base unit is secured to the snap-in adaptor and a separate clamp is attached to the post, thereby defining three parts that need to be assembled by a plumber prior to attachment to the rail. The plumber thereafter typically couples a pipe to the clamp. Various combinations of swivel and quarter-turn clamps can be mated with the post and base unit. Examples of this are shown in U.S. Patent Publication No. 2006/0249634 entitled “Fastening of Pipe Clips” to Van Walraven, which is incorporated by reference herein. While these traditional assemblies have proven quite useful, there are still many separate parts that take time to assemble and can be misplaced in the field. Furthermore, these traditional rails are of a fixed length and are therefore difficult to install in buildings having non-standard stud spacing or in other situations that require a longer or shorter rail mounting arrangement. It would also be desirable to provide different attachment configurations offering different locations and sizes along the rail unlike the traditional approach which contains uniformly sized holes.

In another conventional construction, a conduit clamp having ratchet projections is attached to a bracket. One such exemplary arrangement is disclosed in the U.S. Pat. No. 6,402,096 entitled “Apparatus for Supporting Conduit Between Building Members” which issued to Ismert et al. on Jun. 11, 2002. This patent is incorporated by reference herein. This construction, however, disadvantageously employs a resilient insert which forces a clamp away from a bottom and into contact with offset angled ridges of the bracket in a spring-like and wedging manner. This adds extra parts, expense and assembly time. Moreover, the ratchet and a keeper block of this traditional device are not well suited for misalignment of the conduit relative to the bracket while also not allowing for interchangeability of different types of clamps.

In accordance with the present invention, an interstud rail fastening system is employed. In one aspect, at least one attachment leg, a brim or umbrella, and a coupling post are integrated as a single piece. In another aspect, a clamp is coupled to a fastener having a Christmas tree or stepped type engagement segment which is fastened to a building rail. Furthermore, a multiple step fastener is useable with different size building rails, and with unfilled space being provided between the legs containing the steps, in another aspect of the present system. Yet an additional aspect employs a telescopically adjustable rail in combination with any of the other aspects. Methods of making and using the interstud rail fastening system are also provided.

The present invention is advantageous over traditional devices. For example, the present system reduces parts and assembly time. Furthermore, the Christmas tree feature allows for different mounting of the clamp to the rail. For the multiple step aspect, the fastener can be attached to different size rails, such as different telescopic segments of a rail assembly, in an easy snap-in manner, especially where turned edges of the rail are essentially parallel to a bottom of the rail thereby providing improved pull-out force resistance. In a different stepped embodiment, the fastener is attachable in different sized holes or with different thicknesses of the rail. Certain aspects also advantageously allow for perpendicular, diagonal and even parallel elongated orientations of a tube relative to the rail. Moreover, certain aspects allow for different size clamps to be attached to the fastener after the fastener is attached to the rail, so the plumber can consider the size of tube to be attached before selecting the appropriate clamp, or providing retrofit tubes of different diameter after initial installation. Additional features and advantages of the present invention will be shown and described in reference to the following description and appended figures.

### BRIEF DESCRIPTION OF THE DRAWINGS

FIG. 1 is a perspective view showing first and second embodiments of a clamp and fastener assembly attached to a first embodiment rail;

FIG. 2 is an exploded perspective view showing the first and second embodiments;

FIG. 3 is an enlarged and exploded view, taken opposite that of FIG. 2, showing the first embodiment clamp and fastener assembly;

FIG. 4 is a perspective view showing the fastener of the first embodiment;

FIG. 5 is a fragmentary perspective view showing the first embodiment fastener attached to an inner rail segment;

FIG. 6 is a fragmentary perspective view showing the first embodiment fastener attached to an outer rail segment;

FIG. 7 is a perspective view showing the second embodiment fastener;

FIG. 8 is an exploded perspective view showing a fastener and clamp of a third embodiment;

FIG. 9 is an exploded perspective view, taken opposite that of FIG. 8, showing the third embodiment;

FIG. 10 is a fragmentary perspective view showing the third embodiment fastener and clamp attached to the rail;

FIG. 11 is a fragmentary perspective view showing a fastener and clamp of a fourth embodiment attached to the rail;

FIG. 12 is a perspective view showing a fifth embodiment fastener;

FIG. 13 is an end elevational view showing the fifth embodiment fastener;

FIG. 14 is a fragmentary perspective view showing a second embodiment rail;

FIG. 15 is a fragmentary perspective view showing a third embodiment rail;

FIG. 16 is a perspective view showing a fourth embodiment rail assembly retaining tubes;

FIG. 17 is a perspective view showing a fifth embodiment rail assembly retaining tubes;

FIG. 18 is a perspective view showing a sixth embodiment rail assembly retaining tubes;

FIG. 19 is a perspective view showing a seventh embodiment rail assembly retaining a junction box; and

FIG. 20 is a perspective view showing an eighth embodiment rail assembly retaining the junction box.

### DETAILED DESCRIPTION

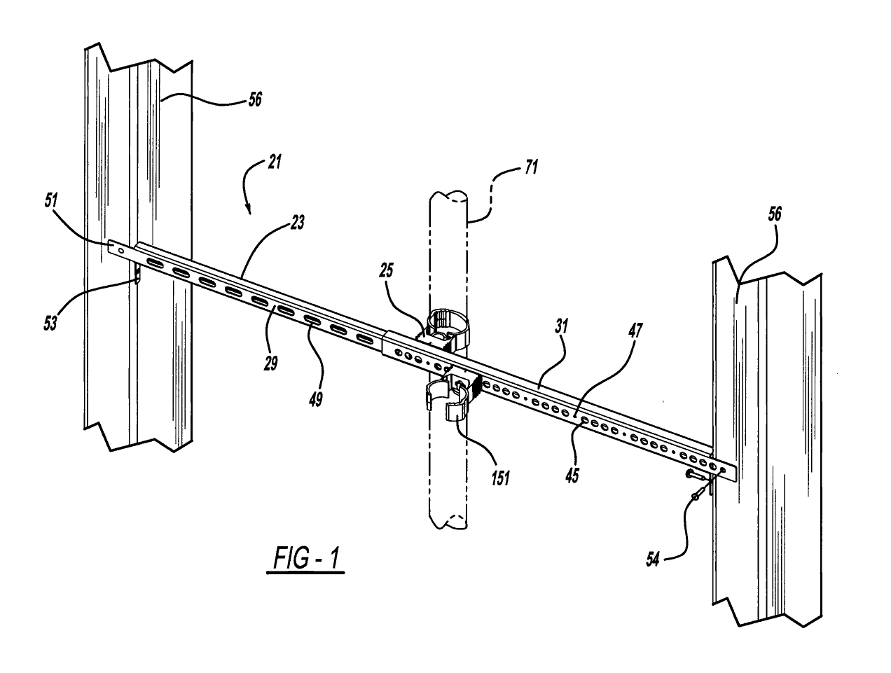

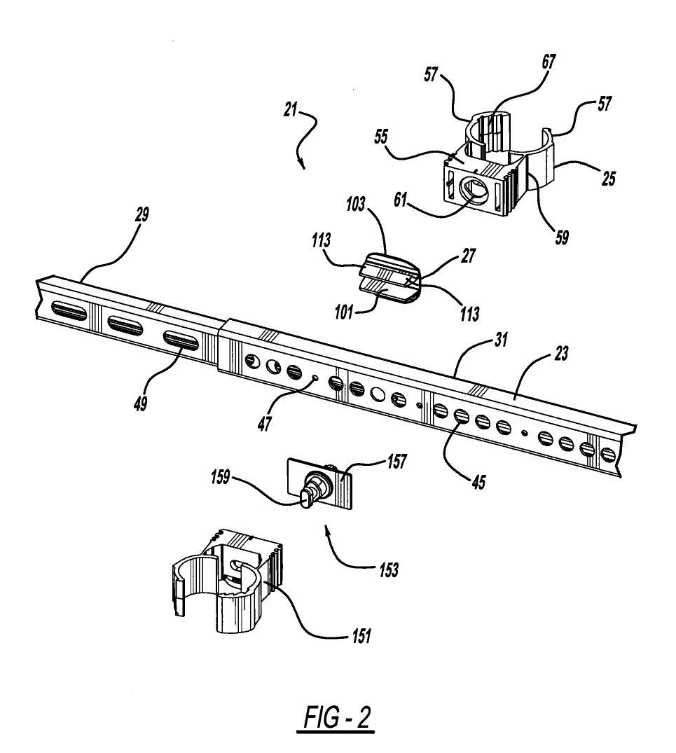

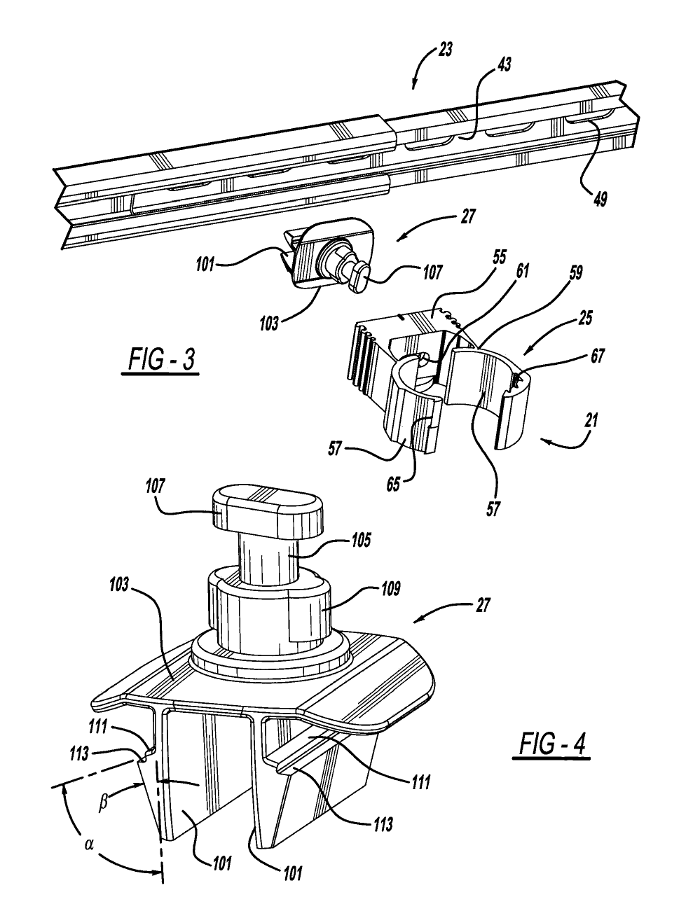

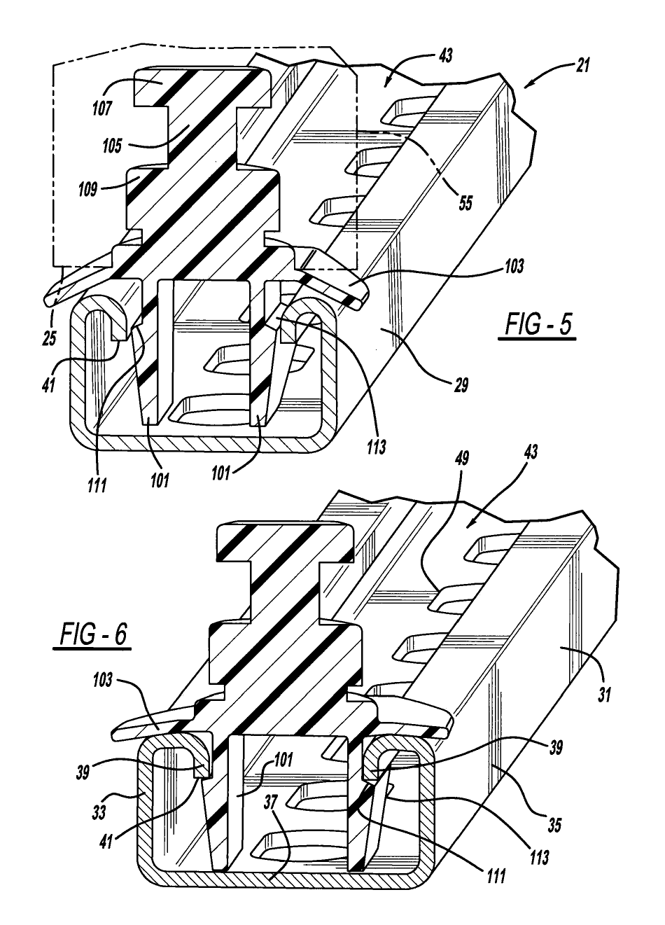

Referring to FIGS. 1-6, an interstud rail fastening assembly 21 includes an elongated rail 23, a clamp 25 and a fastener 27. Rail 23 further includes at least two nested and telescopically adjustable length rail segments 29 and 31, also known as inner and outer rails. Each rail has a generally U-shape (if oriented like FIGS. 5 and 6) defined by a pair of side walls 33 and 35 with a bottom wall 37 spanning therebetween. Adjacent each upper end of side walls 33 and 35 exist an inwardly and approximately 180° turned flange 39 adjacent a cut edge 41. Each flange 39 is essentially perpendicular bottom wall 37 while also being spaced away from the adjacent side walls 33 and 35. An elongated channel opening 43 is defined between flanges 39. Multiple holes of larger circular size 45, smaller circular size 47 and elongated shape 49 are regularly positioned along bottom wall 37 of rails 29 and/or 31. Alternately, such holes may also be positioned along side walls 35 and/or 33.

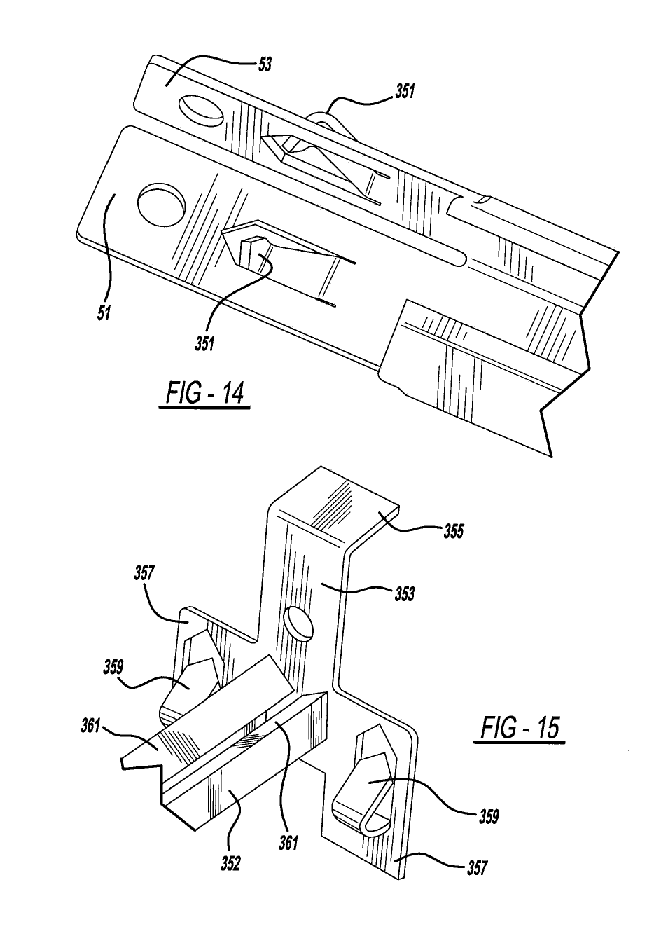

Each outer end of rails 29 and 31 has a pair of deformable tabs 51 and 53 containing holes through which nail or screw fasteners 54 can be inserted. A plumber adjusts the length of the rail and then drives home the fasteners 54 into structural supports 56 of a residential or industrial building, such as wooden or metal studs or joists. Alternately as shown in FIG. 14, tabs 51 and 53 can integrally employ triangularly bent barbs 351 which can be directly hammered into supports 56 instead of employing extra fasteners 54. The embodiment of FIG. 15 provides an additional central tab 353 with an offset flange 355, between pre-formed outboard tabs 357 each having a bent and pointed barb 359. Furthermore, flanges 361 of the FIG. 15 construction are of a diagonally inwardly angled configuration rather than being fully turned as in the first rail embodiment. For each of these rail variations, the rail is preferably cut, pierced and bent, such as by stamping and progressive dies, or alternately roll formed, from 1006 galvanized steel having a 20-gauge thickness, although differing materials and characteristics can alternately be used.

Returning to the first embodiment of FIGS. 1-6, clamp 25 includes a somewhat rectangular-prism body 55 and a pair of generally semi-circular arms 57 which can be rotated relative to body 55 via living hinges 59. An elongated aperture 61 is bordered by undercut ledges along narrower sides thereof. Furthermore, portions of interior and exterior surfaces of each arm 57 are generally smooth and accurate. Distal ends of each arm 57 are tapered and one of the arms has an externately raised barb 65 which engages with one of a series of serrations 67 on the internal surface of the other arm so as to disengageably lock together the arms to define a generally circular and hollow interior area for securing a tube 71 therein. Tube 71 is a rigid fluid-carrying pipe, electrical wire carrying conduit, fiber optic cable, flexible hose or other elongated member which needs to be secured between the studs or joists.

Fastener 27 includes a pair of flexible and longitudinally elongated legs 101, a laterally extending brim or umbrella 103, a longitudinally extending post 105 and a pair of laterally extending formations such as a head 107 and shoulders 109. Rail engagement surfaces or steps 111 and 113 outwardly extend from each leg 101. On each leg, a first step 111 is longitudinally closer to post 105 than a second step 113 while second step 113 is laterally offset further away from leg 101 than is first step 111. Steps 111 and 113 are preferably continuously elongated in a lateral direction between edges of each leg 101. Alternately, however, the first and second step length and lateral configurations can be reversed, depending upon manufacturing ease, rail shape and insertion/extraction force considerations. Each step is generally laterally oriented with a slight downward angle α between about 60-80° relative to the longitudinal direction. A taper angle β of about 65-85° from the longitudinal axis is provided thereby causing insertion force effort to be considerably less than removal or extraction force effort for fastener 27 relative to the rail. Air space or a gap between the spaced apart legs 101 is unfilled during all installation conditions in the rail such that legs 101 are allowed to flex toward each other when removal of the fastener from the rail is desired.

In the installation condition shown in FIG. 6, edges 41 of outer rail segment 31 abut against first steps 111. In the installation condition of FIG. 5, edges 41 of inner rail segment 29 abut against second steps 113. Flexible ends of umbrella 103 are upwardly flexed when installed so as to compress and firmly sandwich the flanges 39 between the umbrella and steps. This deters rattling or vibration of the fastener relative to the rail when fluid is flowing through the secured pipe. This compression also serves to deter undesired sliding of a fastener along the rail channel after complete installation.

Fastener 27 and clamp 25 are preferably separately injection molded from a polymeric material such as POM Celcon® TX90. It should be appreciated, however, that other materials may alternately be employed. It is also noteworthy that the lateral formations, post, umbrella, legs and engagement surfaces are all made as an integrated single piece for the preferred embodiments in order to reduce dimensional variations, reduce separate parts and reduce assembly time in the field.

Clamp 25 is attached to fastener 27 either before or after fastener 27 is inserted into the opening of rail 23. This is performed by orienting the elongated direction of opening 61 in clamp 25 so that it is aligned and fits over head formation 107. Subsequently, clamp 25 is rotated 90° until head formation 107 and/or shoulder formation 109 fully contacts against a stop surface, detent or wedge on a back side of the undercut ledge of body 55. This causes clamp to be securely attached to post 105 by way of a key-hole type of rotational joint. If desired, the clamp body can thereafter be rotated in a reverse direction to disengage it from fastener 27 such that a different size or type of clamp can then be subsequently attached to the same fastener 27; this advantageously prevents the need for disassemblying fastener 27 from rail 23 if a different diameter pipe is later to be installed after initial installation.

Reference should now be made to FIGS. 1, 2 and 7 where a second embodiment fastening system is illustrated. In this configuration, a tube securing clamp 151 and rail 23 are the same as that with the first embodiment. A fastener 153, however, has a Christmas tree segment 155 attached within one of holes 45 or 49 in rail 23. Fastener 153 additionally includes a brim or umbrella 157 which is shown as being flat that may alternately have flexible and bent outside segments. Fastener 153 also includes a laterally extending head formation 159, and shoulder formations 161 projecting from a longitudinally elongated and circular-cylindrical post 163.

Christmas tree segment 155 has a central leg or stem 171 with a tapered lead-in shape adjacent its distal end 173. At least four and more preferably nine branches or fins 175 project from each side of leg 171 in a generally lateral and outward manner. An upper surface of each branch 175 has a substantially flat planar engagement surface 177, perpendicular to the longitudinal direction of leg 171, which contacts against an edge or back side surface defining hole 45 in rail 23. A tapered entry surface for each branch 175 is provided with an angle Ψ of approximately 10-20°, and more preferably 13.8° from the adjacent lateral engagement surface. The entry surface closest to the distal end 173, however, it is provided with a more gradual lead-in taper angle. These angular configurations provide an easier insertion force as compared with a considerably greater extraction force of the fastener engagement to the rail. In the embodiments shown, a single leg 171 with four separate stacked groups of branches are employed, but variations may have two or more spaced apart legs and/or two or more stacked groups of branches. This fastener 153 is preferably injection molded from the same type of material as the prior fastener embodiment.

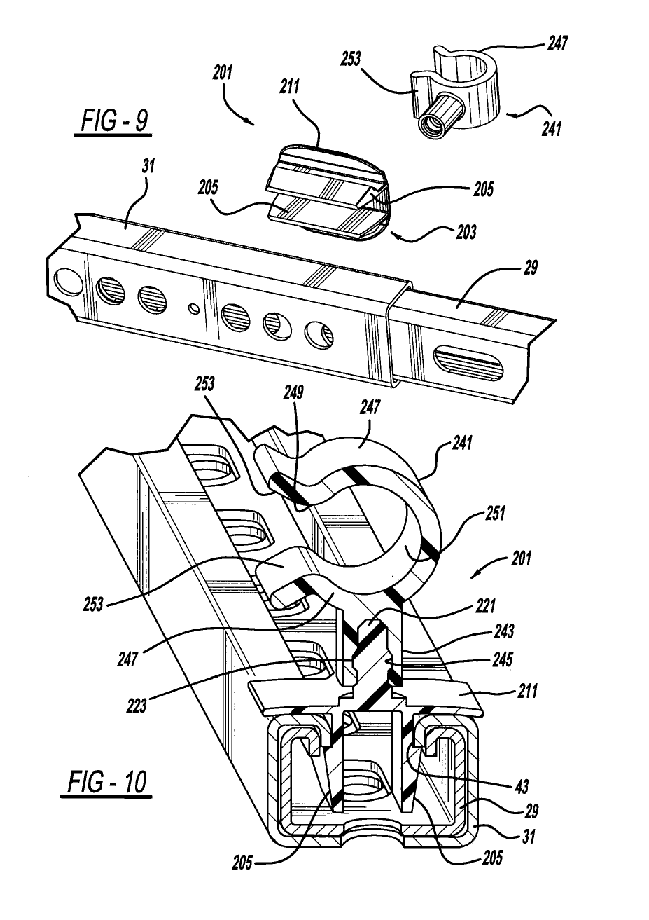

FIGS. 8-10 show a third embodiment fastening system 201. This embodiment employs a rail 23 like that of the prior embodiments. A fastener 203 has the same legs 205 and engagement surface steps 207 and 209 as with the first embodiment, and the same brim or umbrella 211 as the first embodiment. A circularly-cylindrical post 221, however, is provided with a laterally enlarged circular-cylindrical shoulder formation 223 adjacent a longitudinal middle thereof. Undercut post sections of a smaller diameter are located above and below formation 223 so as to provide an interlocking swivel joint when attached to clamp 241.

Clamp 241 has a circular-cylindrical base 243 with an internal cavity including an undercut section 245 operable to receive shoulder formation 223 of post 221 in a linearly inserted snap-fit manner. The angles of the top and bottom of formation 223 can be varied such that assembly forces are less than disassembly forces. In the preferred embodiment, it is desireable to allow disassembly so that alternately sized or shaped clamps can be subsequently attached to fastener 223 if different diameter tubes are desired after initial installation. The swivel joint allows clamp 241 to be rotated relative to fastener 203 and rail 23 after installation in the event that the inserted tube is intentionally or untentionally misaligned (e.g., not perpendicular) relative to rail 23. In one such situation, rail 23 may be diagonally mounted between the building studs or the tube may not be perfectly vertically parallel to the wall studs due to obstacles such as wire junction boxes, plumbing appliances, etc.

Clamp 241 further includes a pair of flexible arms 247 which have generally smooth and curved interior and exterior surfaces defining at least a majority of a circle interrupted by a throat 249. Throat 249 is openly accessible to allow tube entry into a hollow inner receptacle area 251. Furthermore, a pair of diverging walls 253 are provided at ends of arms 247 adjacent throat 249 to allow better access of the tube into receptacle area 251 in a snap-fit manner. Arms 247 define a somewhat C-shape.

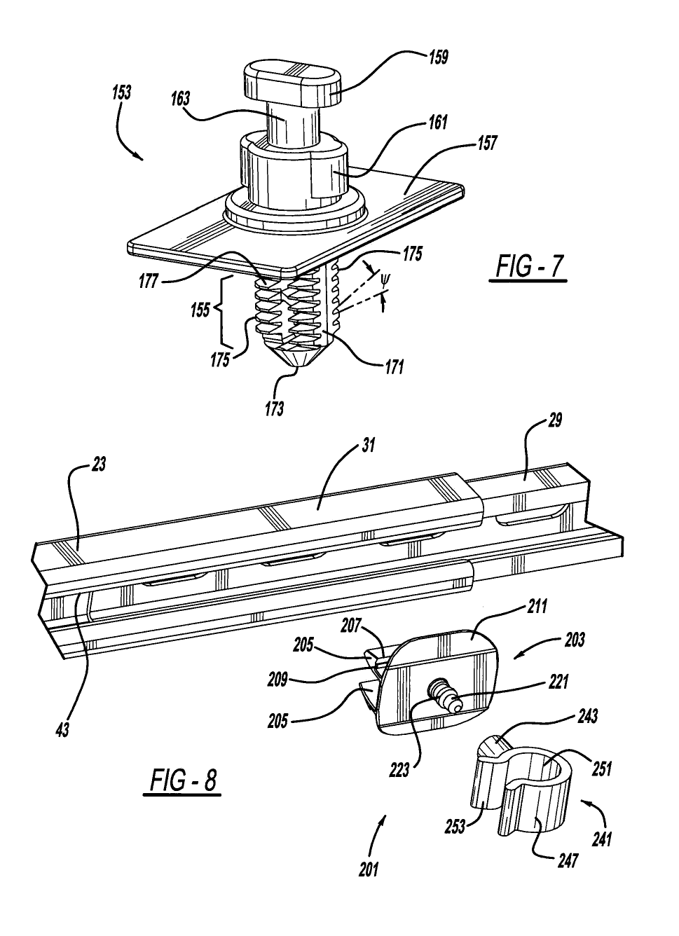

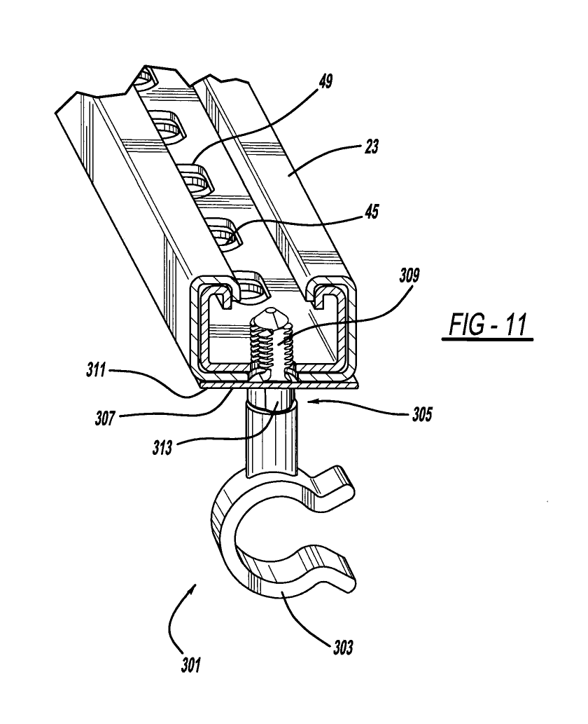

A fourth embodiment fastening assembly 301 can be observed in FIG. 11. A rail 23 is the same as the prior embodiments. Furthermore, a generally C-shaped tube-clamp 303 with a swivel joint 305, like that of the FIG. 10 embodiment, is also used. Fastener 307, however, has a Christmas tree attaching segment 309, like that of the FIG. 7 embodiment, attached to a brim or umbrella 311 and a swivel post 313, like that of the FIG. 10 embodiment. This allows a swivel attachment for a moveable tube-to-rail adjustment while also providing attachment to holes 45 or 49 on the front side of rail 23, which is telescopically adjustable.

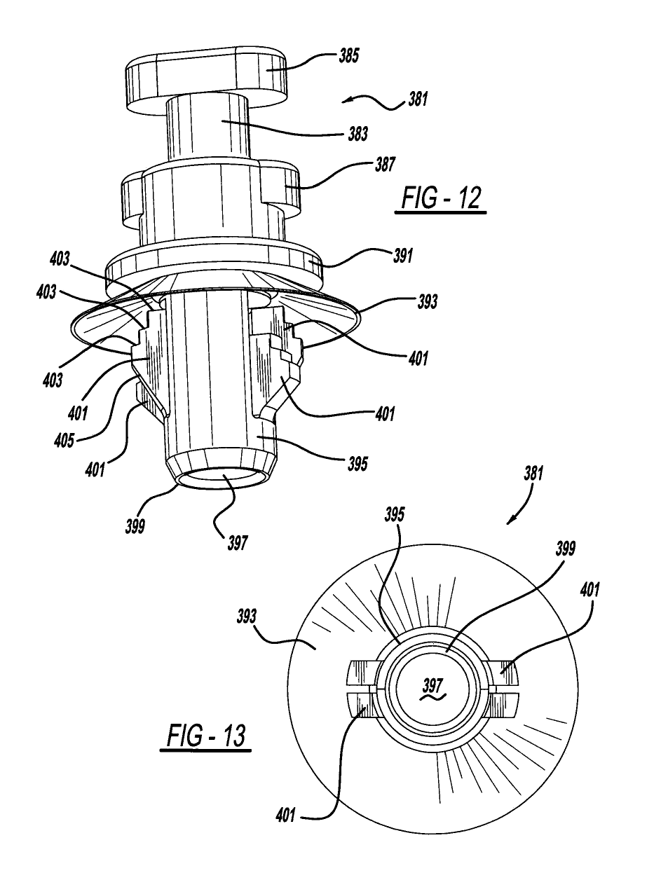

A fifth embodiment fastener 381 is illustrated in FIGS. 12 and 13. This fastener 381 has a post 383, head 385 and shoulders 387 like other configurations disclosed hereinabove for engaging a clamp or the like. An additional lateral ring 391 and flexible, frusta-conical umbrella 393 are also provided. Furthermore, a central leg or stem 395 has a longitudinally elongated and generally cylindrical shape with a hollow center 397 openly accessible at a tapered distal end 399. At least two, and more preferably four, wings 401 have rail engagement surfaces or steps 403 disposed thereon. At least two, and more preferably three, steps 403 are provided on the upper portion of each wing 401 in a graduated manner of differing longitudinal and lateral distances from stem 395 and umbrella 393. Moreover, a diagonally angled and tapered edge 405 of the bottom portion of each wing 401 assists in insertion of fastener 381 into a hole or slot in the rail. Hollow center 397 allows stem 395 to inwardly flex during this insertion and also extraction which requires a much greater force. Cutouts may also be provided in stem 395 between wings 401. Opposite pairs of wings 401 are shown generally parallel to each other with space therebetween, however, all of the wings 401 may alternately radially extend from stem 395 equidistant from each other. Steps 403 accommodate different rail hole sizes or material thicknesses. Fastener 381 is preferably an entirely integrated single piece.

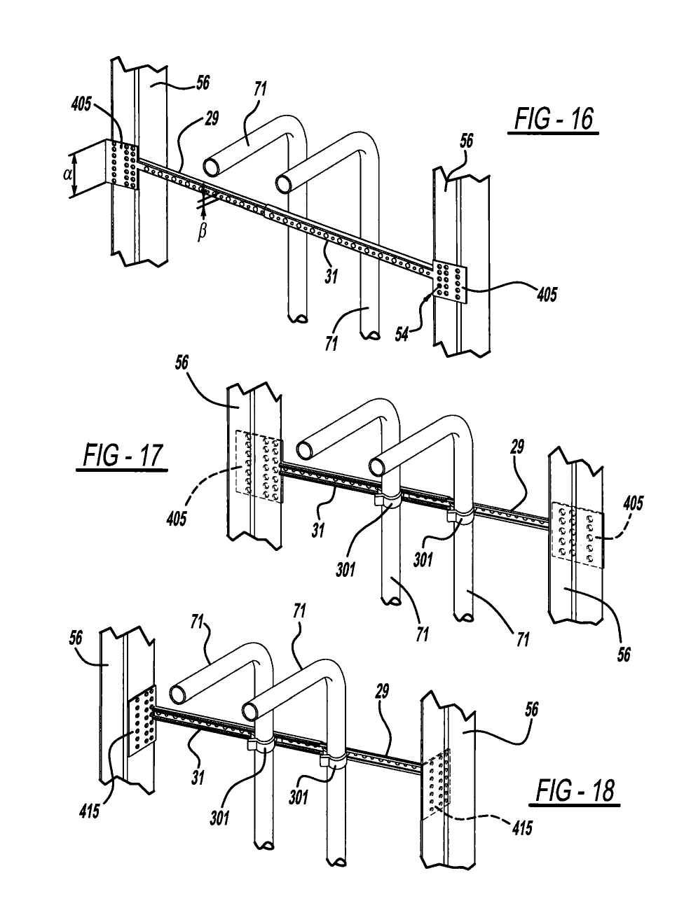

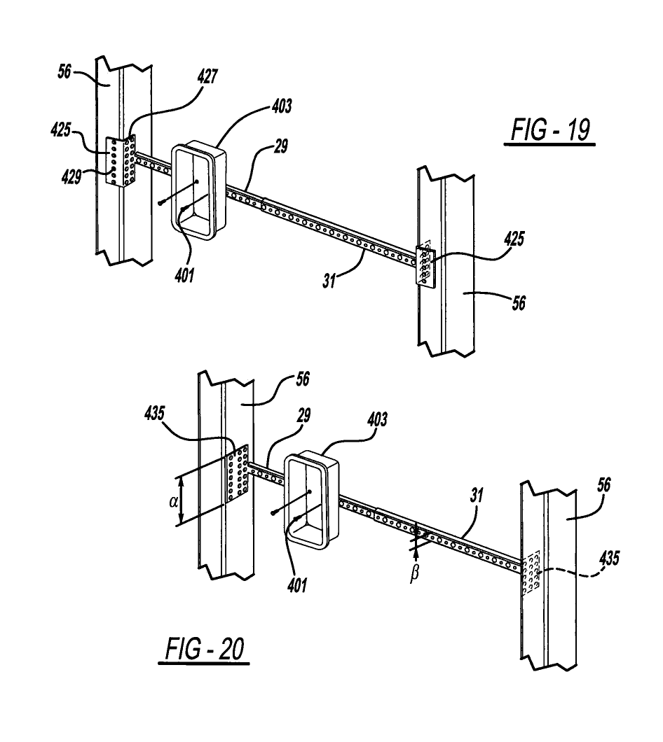

FIGS. 16-20 show different rail configurations for the present fastening system. All of these versions preferably employ stamped metal rails which are nested together to provide telescopic adjustment. Each rail has a generally C-shaped cross-section with inwardly turned flanges as shown in FIGS. 5, 6, 10, 11 and 15. Tubes 71 (see FIGS. 16-18) are attached to back sections of rails 29 and 31 using any of the fasteners discussed herein, such as fastening assembly 301. Alternately, screws 401 are used to secure an electrical junction box 403 (see FIGS. 19 and 20) to holes in front sections of rails 29 and 31.

FIG. 16 illustrates outboard tabs 405 which are flat and substantially co-planar with the front surface of the corresponding rails 29 and 31. Tabs 405 are longitudinally and laterally enlarged relative to the adjacent ends of the rails. Tabs 405 are secured to wooden or metal studs 56 or joists by nails or screws 54 extending therethrough. FIG. 17 illustrates a similar arrangement but with tabs 405 mounted to a backside of studs 56.

As viewed in FIG. 18, the installer can manually (such as with pliers or the floor) bend tabs 415 so that they are substantially perpendicular to the longitudinal orientation of rails 29 and 31. This allows screw mounting of tabs 415 to facing inside surfaces of studs 56.

FIG. 19 shows junction box 403 fastened to rail 29. Each of tabs 425 are either pre-bent in the manufacturing plant or site bent by the installer to have a generally L-shape with an inner section 427 substantially perpendicular to the longitudinally oriented rail and with an outer section 429 substantially parallel to the longitudinal rail orientation. This allows each tab 425 to be screwed to both front and inner surfaces of stud 56 which also uses the stud corner to locate the rails. FIG. 20 provides a similar perpendicular arrangement for tabs 435 as with the FIG. 18 embodiment, but for junction box 403.

For the tabs shown in at least FIGS. 16-20, the lateral (shown as vertical) dimension α is at least twice as large as the corresponding lateral dimension β of the telescopic section of either rail 29 or 31. This advantageously maximizes the stud attachment surface area at each end of the rails. Furthermore, bent barbs (such as 351 or 359 of FIGS. 14 and 15) can be optionally used on tabs 405, 415, 425 and/or 435. It should be appreciated, however, that any of the junction box, tube, fasteners, rails and tabs can be interchanged with each other in any combination.

While various embodiments have been disclosed herein, and it should be appreciated that other variations may be employed. For example, the rail can be extruded or molded from a polymeric material, although various advantages may be forfeit. Furthermore, the arms, post, lateral formations and legs can have polygonal or other cross-sectionally shaped configurations although some of the advantages may not be achieved. The outside shape of the clamp may also differ as long as the function is similar to the embodiments discussed hereinabove, but some of the present benefits may not be realized. Nevertheless, such changes, modifications or variations are not to be regarded as a departure from the spirit and scope of the present invention. The foregoing description of the embodiments has been provided for purposes of illustration and description. It is not intended to be exhaustive or to limit the disclosure. Furthermore, identifiers such as “first,” “second,” “top,” “bottom,” “upper,” “lower,” “side” and the like are not intended to limit the quantity or orientation of the component described since the quantity can be greater and/or the component can be differently oriented in use. Individual elements or features of a particular embodiment are generally not limited to that particular embodiment, but, where applicable, are interchangeable and can be used in a different embodiment, even if not specifically shown or described. Such variations are not to be regarded as a departure from the disclosure, and all such modifications are intended to be included within the scope of the present invention.

The invention claimed is:

1. A fastener system comprising:
(a) an elongated building rail having an opening therein;
(b) a fastener further comprising:
at least one longitudinally elongated leg projecting into the opening and including multiple engagement surfaces oppositely extending away from each other in a substantially lateral manner relative to the at least one longitudinally elongated leg, the engagement surfaces removeably securing the fastener to the rail with a smaller insertion force than an extraction force, and the at least one leg including a taper adjacent a distal end thereof;
a brim outwardly extending adjacent a proximal end of the at least one leg in a substantially lateral manner, the brim being an integral single piece with the at least one leg;
a longitudinally elongated post centrally extending from the brim opposite the at least one leg, the post being an integral single piece with the brim;
a laterally enlarged formation outwardly extending from the post and being spaced away from the brim, the formation being an integral single piece with the post; and
(c) a tube-securing clamp attached to the formation of the fastener, the clamp further comprising at least one moveable arm at least partially surrounding a hollow inner area.

2. The system of claim 1, wherein:
the rail is metal, the fastener is polymeric and the clamp is polymeric;
the rail is telescopically adjustable and adapted for attachment between building structural supports consisting of wall studs or ceiling joists; and
at least one of: the engagement surfaces and the at least one leg, flexes during contact with the rail.

3. The system of claim 2, wherein the rail has a nominal section with a substantially C-cross-sectional shape including inwardly turned flanges defining the longitudinally elongated channel opening therebetween for receipt of the engagement surfaces of the fastener therein, and the rail further comprises a stud-engaging outboard tab which is bendable relative to the nominal section of the rail, the tab having a lateral dimension at least twice as large as a corresponding lateral dimension of the nominal section.

4. The system of claim 1, wherein the fastener further comprises:
a shoulder laterally extending from the post spaced away from the formation and from the brim;
the formation being located on a distal end of the post;
the at least one leg including a pair of legs spaced apart from each other; and
the brim laterally extending further than the engagement surfaces, the shoulder and the formation.

5. The system of claim 1, further comprising a tube being a fluid-carrying pipe, the pipe being removeably attached within the hollow inner area of the clamp, the clamp securing the pipe to the rail via the fastener, the fastener being repositionable along the rail.

6. The system of claim 1, wherein the at least one leg and engagement surfaces are part of a Christmas tree attachment located within the opening of the rail, at least four of the engagement surfaces per side being angled to prove greater resistance to removal than insertion to the rail.

7. The system of claim 1, wherein the clamp is rotatable relative to the fastener in at least one condition, and the clamp is a separate piece from the fastener.

8. The system of claim 1, wherein the at least one arm of the clamp has a substantially C-shape and is flexible to accept tube insertion through an open throat and into the hollow inner area, the throat always remaining open.

9. The system of claim 1, wherein the at least one arm of the clamp includes a pair of arms which are moveable between an opening position allowing access to the hollow inner area, and a closed position causing total enclosure of the hollow inner area, the clamp further comprising a base with a hole and an adjacent ledge therein receiving the formation and post of the fastener such that the clamp is attached to the fastener through a rotational motion.

10. The system of claim 1, wherein the rail is telescopically adjustable, the rail further comprising inner and outer rail segments each comprising a substantially U-shaped cross-section and inwardly turned end flanges such that the flanges adjacent edges thereof are perpendicular to a bottom wall of the U-shaped cross-section, the space between the flanges defining an elongated channel, the bottom walls of the inner and outer rail components each comprising holes of different sizes, and at least one of the channel and holes being the opening which receives the fastener.

11. The system of claim 1, wherein the engagement surfaces of the fastener define different steps longitudinally and laterally spaced along the at least one leg, a lower and outer of the steps engaging a first surface defining the opening which is in a first size of the rail, and an upper and outer of the steps engaging a second surface defining the opening which is in a second and different size of the rail, the upper step being closer to the brim than the lower step, and the brim including a flexibly offset umbrella, the rail being compressed between the umbrella and the engaged steps.

12. The system of claim 1, wherein the at least one leg is a single hollow stem extending from the brim which is a flexible umbrella, and the engagement surfaces are located on wings laterally projecting from the stem, the engagement surfaces including at least two steps on each wing facing toward the umbrella.

13. A fastener system comprising:
an elongated building rail having at least one surface defining an opening;
a fastener further comprising at least one central stem including multiple offset rail engagement surfaces outwardly extending from opposite sides of the stem, at least some of the surfaces engaging the at least one surface defining the opening in the rail, and a brim coupled to the at least one stem and extending in a substantially lateral direction; and
a fluid-carrying pipe-clamp attached to the fastener, the clamp including a pair of arms having inside surfaces defining at least a majority of a substantially circular shape around an open pipe-receiving area when in at least one condition, at least one of the arms being moveable relative to a segment of the clamp that is attached to the fastener.

14. The system of claim 13, further comprising diverging lead-in formations extending from opposite ends of the arms adjacent an open throat, the movement of the at least one of the arms being flexure when a fluid-carrying pipe is inserted therein.

15. The system of claim 13, wherein the clamp is a separate piece from the fastener, the fastener is of a Christmas tree type with the engagement surfaces thereof being on longitudinally spaced branches, and the rail is located between at least some of the branches and the clamp.

16. The system of claim 13, wherein the at least one stem is a single and longitudinally elongated stem with a tapered distal end, there are at least three of the engagement surfaces on each side of the stem, the engagement surfaces are angled to make a rail insertion force less than an extraction force, the fastener further comprises a post longitudinally extending from an opposite face of the brim from the stem, the brim is laterally wider than the engagement surfaces, and the brim contacts the rail.

17. The system of claim 13, further comprising an interlocking swivel joint coupling the clamp to the fastener so that the clamp is rotatable relative to the fastener and the rail.

18. The system of claim 13, further comprising a rotatable joint coupling the clamp to the fastener in a removeable manner.

19. The system of claim 13, further comprising a fluid-carrying pipe removeably attaching within the open area of the clamp, and the clamp securing the pipe to the rail via the fastener.

20. The system of claim 13, wherein:
the rail is metal, the fastener is polymeric and the clamp is polymeric; and
the rail is telescopically adjustable and adapted for attachment between building structural supports consisting of wall studs or ceiling joists.

21. The system of claim 13, wherein the at least one stem has a hollow center accessible from a tapered distal end, and the engagement surfaces are steps on wings laterally extending from the stem, each of the wings including at least two of the steps thereon facing toward the brim which is a flexible umbrella.

22. A fastener system comprising:
a clamp including a partially circular internal surface and a partially circular external surface, at least a majority of the surfaces being smooth, and the internal surface defining a receptacle area therein; and
at least two spaced apart members each having at least a first step and a second step outwardly projecting therefrom, the members having a space between them at least a majority of which is open and unfilled during clamping by the clamp such that the members can flex toward each other even during clamping;
for each member, the first step being located closer to the clamp and inboard relative to the second step; and
each of the members including a tapered shape narrowing away from the clamp.

23. The system of claim 22, further comprising a post longitudinally extending centrally and oppositely from the members, the clamp being coupled to the post, the post being an integrated single piece with the members.

24. The system of claim 23, further comprising an at least partially flexible umbrella being located between the members and the post, the umbrella laterally extending further than the steps, the umbrella being an integrated single piece with the members.

25. The system of claim 22, wherein the clamp is rotatable relative to the members.

26. The system of claim 22, wherein each member has at least a pair of the steps, with at least one of the steps of each member being laterally spaced apart from the other, the steps closest to a distal end of each of the member locally projecting in substantially triangular formations.

27. The system of claim 22, further comprising a telescoping hollow bracket including an edge defining an opening therein, the first step being adapted to engage the edge of a first size of the bracket and the second step being adapted to engage the edge of a second and different size of the bracket.

28. The system of claim 22, further comprising a fluid-carrying pipe removeably secured within the internal surface of the clamp, the clamp and member being polymeric, and the clamp being a separate part from the members but attached together in at least one condition.

29. The system of claim 22, wherein the internal surface of the clamp defines at least a majority of a circle and has an open throat in at least one condition.

30. A fastener system comprising:
(a) a telescopically adjustable length rail further comprising differently sized rail segments;
(b) a fastener further comprising at least two spaced apart members each having multiple rail-engaging surfaces projecting therefrom which allow the fastener to be attached to any of the rail segments, the members having a space between them at least a majority of which is open and unfilled when attached to the rail; and
(c) a clamp adapted to secure an elongated member, the clamp being coupled to the fastener.

31. The system of claim 30, wherein the clamp includes at least one arm with a partially circular interior which secures the member therein, and the member is a fluid-carrying pipe in a building.

32. The system of claim 30, further comprising an interlocking swivel joint coupling the clamp to the fastener so that the clamp is rotatable relative to the fastener and the rail.

33. The system of claim 30, wherein:
the rail is metal, the fastener is polymeric and the clamp is polymeric;
the rail has deformable end flanges adapted for attachment between building structural supports consisting of wall studs or ceiling joists; and
the rail-engaging surfaces of the fastener are laterally offset and outwardly projecting steps.

34. The system of claim 30, further comprising:
a post longitudinally extending centrally and oppositely from the members, the clamp being coupled to the post; and
an at least partially flexible umbrella being located between the members and the post, the umbrella laterally extending further than the steps;
the members, post and umbrella all being an integrated single piece.

35. The system of claim 30, wherein the rail segments further comprise an inner rail segment nested in an outer rail segment, each of the rail segments has a substantially U-shape a bottom of which includes multiple holes, turned flanges define an elongated channel adjacent edges of each rail segment, a turned wall adjacent each edge being perpendicular to the bottom each of the rail segments, and at least one of the surfaces of each leg engages the edge of one of the rail segments.

36. The system of claim 30, wherein the rail includes different size holes spaced along a majority length of the rail, at least multiples of the holes are round and adapted for mounting of a screw therein, and at least multiples of the holes are elongated.

37. The system of claim 30, wherein the members are wings laterally extending from a single and hollow central stem.

38. The stem of claim 30, wherein the members are legs that have substantially inner flat surfaces facing each other in a spaced apart relationship, and each of the legs has a lateral dimension perpendicular to a central post which is greater than a longitudinal dimension substantially parallel to the post, and the rail-engaging surfaces on each of the legs extending at least a majority of the lateral dimension.

39. A fastener system comprising:
a first interstud rail comprising a substantially C-cross-sectionally shaped nominal section including inwardly turned flanges defining a longitudinally elongated opening therebetween, and the nominal section further including multiple holes longitudinally spaced apart on a surface thereof;
at least a second interstud rail comprising a substantially C-cross-sectionally shaped nominal section including inwardly turned flanges defining a longitudinally elongated opening therebetween;
the rails being nested together to allow for telescopic elongation thereof in the longitudinally elongated direction;
at least one outboard tab located on an end of at least one of the rails, the tab having a lateral dimension at least twice as big as a lateral dimension of the adjacent nominal section, and the tab being manually bendable by an installer; and
a fastener comprising flexible legs with laterally facing engagement surfaces snapping into engagement with the turned flanges of at least one of the rails.

40. The system of claim 39, wherein the tab has a substantially L-shape, and at least one of a tube and a junction box is attached to at least one of the rails.

41. The system of claim 39, wherein the tab includes a pointed barb which is bendable for stud-engagement, the fastener further comprises at least one arcuate clamp which is removeable from the legs, and an open space is between distal ends of the legs.

42. A method of using a fastening system, the method comprising:
(a) telescopically adjusting a length of a bracket;
(b) attaching ends of the bracket to building structural members;
(c) snapping members of a fastener into an opening in the bracket;
(d) engaging at least one of multiple steps of each member with a surface adjacent the opening of the bracket, the steps being laterally and longitudinally offset from each other allowing for use of the fastener with different sizes of the bracket;
(e) causing distal ends of the members to be spaced apart from each other with an air gap therebetween when the fastener is attached to the bracket so that the members can be flexed toward each other to allow removal of the fastener from the bracket; and
(f) holding an elongated member within an arm coupled to the fastener, the arm having at least partially curved and smooth interior and exterior surfaces at least prior to the holding of the member.

43. The method of claim 42, further comprising:
(a) attaching a clamp body to a post centrally projecting from the fastener opposite the members, the arm flexibly extending from the clamp body; and thereafter
(b) rotating the arm relative to the fastener.

44. A method of making a fastening system, the method comprising:
(a) creating from a polymer a single piece fastener comprising at least one elongated leg, at least two engagement surfaces outwardly extending from a single side of the at least one leg, an umbrella adjacent a proximal end of the at least one leg, a central post extending from the umbrella, and at least one of: the at least one leg and the at least two engagement surfaces, being flexible during fastening;
(b) creating from a polymer a pipe-retainer; and
(c) coupling together the retainer and the fastener such that at least a segment of the retainer is moveable relative to the fastener thereafter.

45. The method of claim 44, further comprising:
(a) cutting and bending telescopically extendable rail segments;
(b) nesting together the rail segments;
(c) attaching the rail segments to a building;
(d) attaching the engagement surfaces within an opening of at least one of the rail segments; and
(e) clamping a fluid-carrying pipe in the retainer.

46. The method of claim 44, wherein the step of creating the fastener further comprises injection molding Christmas tree branches including the engagement surfaces from the at least one leg, and creating the umbrella between the post and the at least one leg so that at least end sections of the umbrella are flexible.

47. The method of claim 44, further comprising injection molding a diagonally tapered surface adjacent a distal end of multiples of the leg which are spaced away from each other, the engagement surfaces being on outer surfaces of the legs.

48. The method of claim 44, further comprising creating a hollow stem from which multiples of the leg laterally and oppositely extend.
